(19) United States
(12) Patent Application Publication
(10) Pub. No.: US 2009/0237679 A1
(43) Pub. Date: Sep. 24, 2009

(54) IMAGE PROCESSING DEVICE AND METHOD FOR IMAGE PROCESSING

(75) Inventor: Masaya USUI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/399,388

(22) Filed: Mar. 6, 2009

(30) Foreign Application Priority Data
Mar. 24, 2008 (JP) 2008-076268

(51) Int. Cl. G06K 15/02

(52) U.S. Cl. 358/1.2

(57) ABSTRACT

An image processing device having a deformation area setting unit and a deformation processing unit is provided. The deformation area setting unit is configured to set an extension area and a reduction area in an image. The deformation processing unit is configured to extend the extension area in a particular direction, the deformation processing unit being configured to reduce the reduction area in the particular direction at a constant reduction rate.

### BACKGROUND

1. Technical Field

The present invention relates to an image processing technology for deforming an image.

2. Related Art

An image processing technology for deforming and reducing a human face included in a digital image is known as disclosed in JP-A-2004-318204. An image processing device disclosed in JP-A-2004-318204 is configured to set a portion of an image of a face (portion representing an image of a cheek) as a correction area, to divide the correction area into a plurality of sub-areas in accordance with a determined pattern, and to expand or reduce the image at a magnification set sub-area by sub-area so as to deform the facial shape.

The image processing technology of correcting the image by setting the correction area, however, requires a large amount of arithmetic operation such as setting the correction area, expanding or reducing the sub-areas and so on. Thus, the amount of arithmetic operation may often be excessively large. The above problem is not limited to a case of deforming the human face, and is common to processes for deforming an image in general.

### SUMMARY

An advantage of some aspects of the invention is to reduce an amount of arithmetic operation required by an image deformation process for deforming an image.

Another advantage of some aspects of the invention is to at least partially address the above problem. The invention can be implemented as following embodiments or applications.

### First Application

An image processing device including a deformation area setting unit configured to set an extension area and a reduction area in an image, and a deformation processing unit configured to extend the extension area in a particular direction, the deformation processing unit being configured to reduce the reduction area in the particular direction at a constant reduction rate.

According to the first application, the image processing device deforms the image by extending and reducing the image in one direction so that an amount of arithmetic operation required by the image deformation process can be reduced. The image processing device sets the reduction rate to be constant in the reduction area so as to suppress a feeling of wrongness of the deformed image caused by a change of the reduction rate within the reduction area.

### Second Application

The image processing device according to the first application, wherein the deformation processing unit is configured to assign a first extension rate and a second extension rate to a first position and a second position in the extension area, respectively, the second position being nearer to the reduction area than the first position, the second extension rate being smaller than the first extension rate.

According to the second application, the extension rate of the second position that is nearer to the reduction area is smaller than the extension rate of the first position that is distant from the reduction area. Thus, as a change of the magnification between the reduction area and the extension area is suppressed, the image processing device can suppress a feeling of wrongness of the deformed image.

### Third Application

The image processing device according to the second application, wherein the deformation processing unit is configured to extend the extension area in the particular direction at an extension rate monotonously increasing with a distance in the particular direction from the reduction area.

The image processing device makes the extension rate monotonously increase with the distance in the particular direction from the reduction area so as to reduce a change rate of the extension rate in the particular direction in the extension area. Thus, the image processing device can suppress a feeling of wrongness of the deformed image caused by an abrupt change of the extension rate in the particular direction.

### Fourth Application

The image processing device according to the first application, wherein the image includes a human face, and the deformation area setting unit is configured to set the reduction area in such a way that the reduction area includes the human face.

In general, if an amount of deformation of a facial shape is not uniform, the deformed image produces a feeling of wrongness. According to the fourth application, as the reduction area in which the reduction rate is constant includes the human face, the face can be more uniformly deformed. Thus, the image processing device can suppress a feeling of wrongness of the deformed image.

The invention can be implemented in various forms such as a method and a device for image processing, an image output device and a method for outputting an image using the above method and device for image processing, a computer program for implementing the above methods and functions of the above devices, a storage medium on which the above computer program is recorded, a data signal including the above computer program and implemented in a carrier wave, and so on.

### BRIEF DESCRIPTION OF THE DRAWINGS

The invention will be described with reference to the accompanying drawings, wherein like numbers reference like elements.

FIG. 1 is a schematic block diagram of a printer of a first embodiment.

FIG. 2 illustrates an example of a user interface screen including a list of images.

FIG. 3 is a flowchart of a facial shape correction print process performed upon the printer performing facial shape correction printing.

FIGS. 4A-4C illustrate an example of the facial shape correction process in which an image corresponding to a thumbnail TN1 shown in FIG. 2 is corrected.

FIG. 5 is a flowchart of a deformation process performed at a step S400.

FIGS. 6A-6C show a model of the deformation process in a case where a direction of deformation is horizontal.

FIGS. 7A-7C illustrate a facial shape correction process in which an image corresponding to a thumbnail image TN2 shown in FIG. 2 is corrected.

FIGS. 8A and 8B illustrate a facial shape correction process of a second embodiment in which an image corresponding to a thumbnail image TN1 shown in FIG. 2 is corrected.

FIG. 9 is a schematic block diagram of a printer of a third embodiment.

FIG. 10 is a flowchart of a facial shape correction print process of the third embodiment.

FIGS. 11A and 11B illustrate a facial shape correction process of the third embodiment in which the image corresponding to the thumbnail image TN1 shown in FIG. 2 is corrected.

FIGS. 12A and 12B illustrate a facial shape correction process in which an image corresponding to a thumbnail image TN3 shown in FIG. 2 is corrected.

FIG. 13 is a schematic block diagram of a printer of a fourth embodiment.

FIG. 14 is a flowchart of a facial shape correction print process of the fourth embodiment.

FIGS. 15A and 15B illustrate a facial shape correction process of the fourth embodiment in which the image corresponding to the thumbnail image TN3 shown in FIG. 2 is corrected.

FIG. 16 is a schematic block diagram of a printer of a fifth embodiment.

FIG. 17 is a flowchart of a facial shape correction print process of the fifth embodiment.

FIGS. 18A-18C illustrate a facial shape correction process of the fifth embodiment in which the image corresponding to the thumbnail image TN1 shown in FIG. 2 is corrected.

FIGS. 19A and 19B illustrate an example of a facial arrangement identification process performed at a step S200 shown in FIG. 3.

FIG. 20 illustrates an example of a facial arrangement identification process performed at a step S800d shown in FIG. 17.

FIG. 21 illustrates another example of the facial arrangement identification process performed at the step S800d shown in FIG. 17.

FIG. 22 illustrates still another example of the facial arrangement identification process performed at the step S800d shown in FIG. 17.

FIG. 23 illustrates yet another example of the facial arrangement identification process performed at the step S800d shown in FIG. 17.

### DESCRIPTION OF EXEMPLARY EMBODIMENTS

Embodiments of the invention will be described in following paragraphs in order.
A. First Embodiment
B. Second Embodiment
C. Third Embodiment
D. Fourth Embodiment
E. Fifth Embodiment
F. Facial Arrangement Identification
G. Facial Area Deformation
H. Modifications

### A. First Embodiment

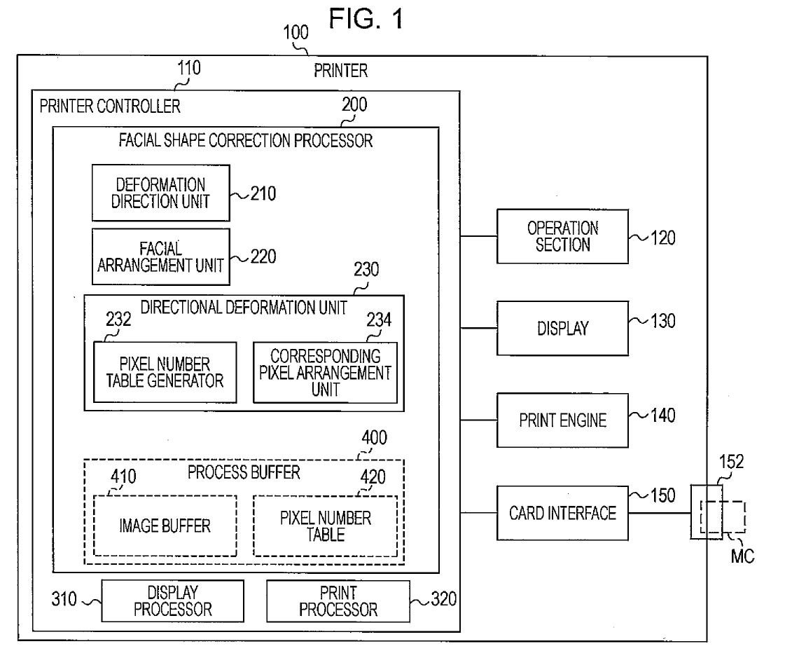

FIG. 1 is a schematic block diagram of a printer 100 of the first embodiment of the invention. The printer 100 is a color inkjet printer adapted for so-called direct printing configured to print an image on the basis of image data obtained from a memory card MC and so on. The printer 100 has a printer controller 110 configured to control each of portions of the printer 100, an operation section 120 constituted by buttons and a touch-panel, a display unit 130 constituted by a liquid crystal display device, a print engine 140, and a card interface 150. The printer 100 may further have an interface configured to perform data communication with other devices (e.g., a digital still camera or a personal computer).

The print engine 140 is a printing mechanism configured to perform printing on the basis of print data. The card interface 150 is an interface for exchanging data with the memory card MC loaded into a card slot 152. The memory card MC of the first embodiment stores image data being RGB data. The printer 100 may obtain the image data stored in the memory card MC through the card interface 150.

The printer controller 110 has functional blocks that are a facial shape correction processor 200, a display processor 310, and a print processor 320. The printer controller 110 is constituted as a computer having a CPU, a ROM and a RAM (which are not shown). The CPU is configured to work as the above functional blocks 200, 310 and 320 by running programs stored in the ROM or the RAM.

The display processor 310 is configured to control the display unit 130 so as to display a processing menu or a message on the display unit 130. The print processor 320 is configured to generate the print data from the image data, and to control the print engine 140 so as to print an image based on the print data.

The facial shape correction processor 200 has a deformation direction setting unit 210, a facial arrangement identification unit 220 and a directional correction process unit 230. The directional correction process unit 230 has a corresponding pixel number table generator 232 and a corresponding pixel arrangement process unit 234. The directional correction process unit 230 is configured to perform a facial shape correction process by using an image buffer 410 and a corresponding pixel number table 420 both included in a process buffer 400 that is an area for temporary memory arranged in the RAM. A function of each of the above portions will be described later.

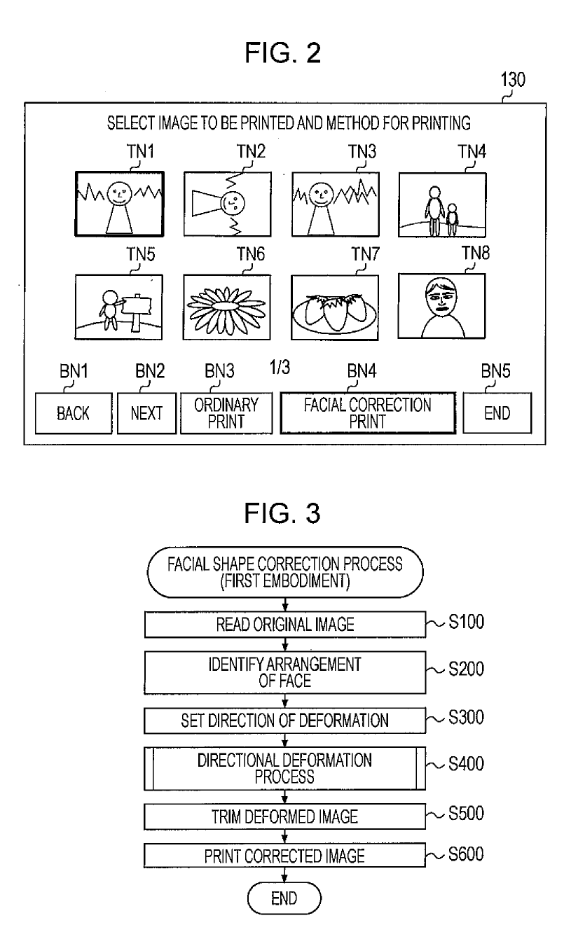

The printer 100 is configured to print an image on the basis of image data stored in the memory card MC. If the card slot 152 is loaded with the memory card MC, the display controller 310 displays on the display unit 130 a user interface screen including a list of images stored in the memory card MC. FIG. 2 shows an example of the user interface screen including the list of the images. The list of the images of the embodiment is implemented by using thumbnail images included in the image data (image files) stored in the memory card MC. The user interface screen shown in FIG. 2 includes eight thumbnail images TN1-TN8 and five buttons BN1-BN5. The deformation direction setting unit 210 corresponds to a deformation area setting unit. The directional correction process unit corresponds to a deformation processing unit.

If a user selects one of the images on the user interface screen shown in FIG. 2 and presses the ordinary print button BN3, the printer 100 performs ordinary printing, i.e., print the selected image as usual. Meanwhile, if the user selects one of the images on the user interface screen and presses the facial correction print button BN4, the printer 100 performs a facial shape correction process on the selected image so as to reduce a width of a face of the selected image, and prints the corrected image. As shown in FIG. 2, e.g., the thumbnail image TN1 is selected and the facial correction print button BN4 is pressed. Thus, the printer 100 performs the facial shape correction process on the image corresponding to the thumbnail image TN1, and prints the corrected image.

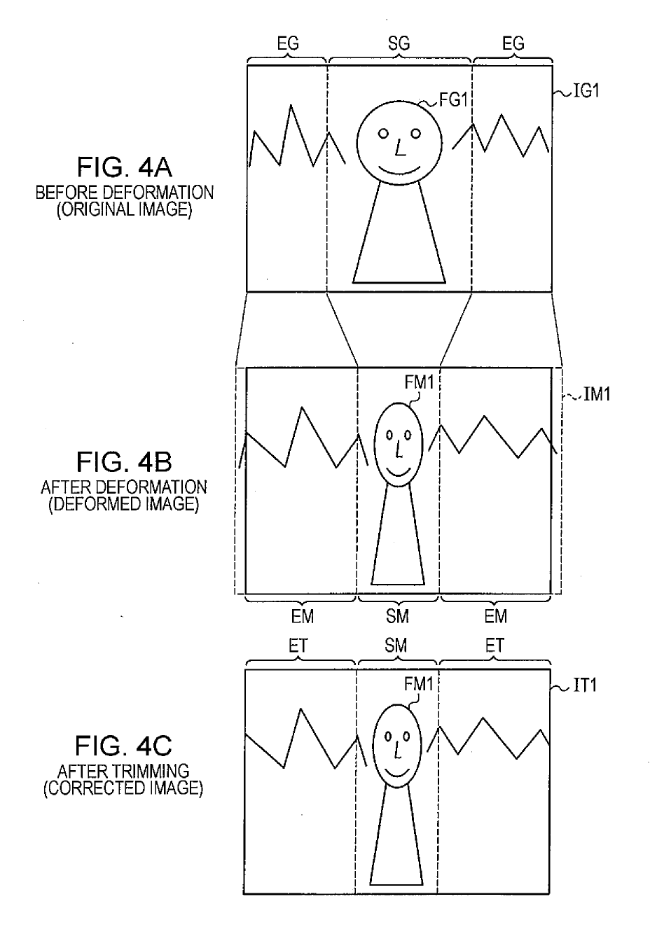

FIG. 3 is a flowchart showing a flow of a facial shape correction print process that the printer 100 performs for facial shape correction printing. The CPU of the printer controller 110 may perform the facial shape correction print process in response to a user's operation on the facial correction button print BN4 on the user interface screen shown in FIG. 2. FIGS. 4A-4C illustrate an example of the facial shape correction process in which an image IG1 corresponding to the thumbnail image TN1 is corrected and a corrected image IT1 is produced.

At a step S100, the facial shape correction unit 200 (shown in FIG. 1) obtains an image to be corrected by the facial shape correction process. More specifically, the facial shape correction unit 200 reads from the memory card MC the image (object image) corresponding to the thumbnail image TN1 selected by the user on the user interface screen shown in FIG. 2, and stores the object image in the image buffer 410. Hereinafter, the image to be corrected by the facial shape correction process may be called the “original image”.

At a step S200, the facial arrangement identification unit 220 (shown in FIG. 1) analyzes the original image so as to identify an arrangement of the human face in the original image. More specifically, the facial arrangement identification unit 220 detects the human face and identifies an inclination of the detected face to the image. As for the first embodiment, long and short sides of the image are in horizontal and vertical directions, respectively. Thus, the inclination of the face is a degree between a top-to-bottom direction of the face and the vertical direction (i.e., the short side direction) of the image. A specific method for identifying the facial arrangement will be described later. As detecting the human face while identifying the facial arrangement, the facial arrangement identification unit 220 has a function of a “face detector”. As long as the facial arrangement may be identified, the face detector may detect at least one organ included in the face, or may detect a whole head. As being determined to the face, the top-to-bottom or left-to-right direction of the face may be called a direction preset to the face.

As shown in FIG. 4A, e.g., a face FG1 positioned almost in the middle of the original image IG1 is detected, and the inclination of the face FG1 is identified. As shown in FIG. 4A, the top-to-bottom direction of the face FG1 almost coincides with the vertical direction of the image IG1. Thus, the inclination of the face identified at the step S200 is almost zero degrees.

At a step S300 shown in FIG. 3, the deformation direction setting unit 210 sets a direction of deformation, i.e., an extension and a reduction, in the facial shape correction process on the basis of the facial arrangement identified at the step S200. More specifically, if the inclination of the face obtained at the step S200 is smaller than 45 degrees, the direction of deformation is set in the horizontal direction of the image. Meanwhile, if the inclination of the face is greater than 45 degrees, the direction of deformation is set to be vertical. If the inclination of the face is 45 degrees, the direction of deformation is set in a standard direction (e.g., horizontal) that has been determined in advance. It the image data includes Exif information, the direction of deformation may be set on the basis of position change information included in the Exif information instead of in the standard direction. If the inclination of the face is in a determined range including 45 degrees (e.g., 43-47 degrees), the direction of deformation may be set in the standard direction or on the basis of the position change information.

As described later, the top-to-bottom direction of the face is identified as a direction perpendicular to a direction connecting two pupils of the detected face. Thus, the direction of deformation is set in one of the horizontal and vertical directions of the image that makes a smaller degree with the direction connecting the pupils.

If the image includes a plurality of faces, the direction of deformation is set by preferably using a greater one of the faces. That is, if the inclination of the greater face is smaller than 45 degrees and the inclination of the smaller face is greater that 45 degrees, the direction of deformation is set to be horizontal. If the image includes a plurality of faces, though, the direction of deformation may be set by using other methods. The direction of deformation may be set on the basis of the inclination of the face closest to zero or ninety degrees, or on the basis of a direction of an arrangement of the plural faces.

As shown in FIG. 4A, e.g., the inclination of the face FG1 is almost zero degrees so that the direction of deformation is set in the horizontal direction of the image IG1 at the step S300 (shown in FIG. 3).

At a step S400, the directional correction process unit 230 (shown in FIG. 1) performs a directional correction process for reducing and extending the original image in the direction of deformation so as to produce a corrected image. More specifically, the directional correction process unit 230 reduces and extends in the direction of deformation a reduction area of a determined width arranged in the middle of the direction of deformation and extension areas arranged outside the reduction area, respectively. The width of the reduction area may be set on the basis of a width of the face detected at the step S200, or a length of the original image in the direction of deformation. The reduction area may be set to, e.g., two and a half times as wide as the face, or to half as long as the direction of deformation.

on an image where a person is photographed, as usual, the person is arranged in the middle of the image. Thus, by arranging the reduction area in the middle of the original image, the human face included in the image is deformed and slims down. Although the first embodiment is given a reduction rate determined beforehand (e.g., 90 percent), the user may instruct to change the reduction rate. An extension rate of the extension area is properly set on the basis of the width and the reduction rate of the reduction area. A specific configuration of the directional deformation process will be described later.

As for the first embodiment, as shown in FIG. 4A, a reduction area SG is arranged in the middle of the horizontal direction (direction of deformation) of the original image, and an extension area EG is arranged at each of the left and right outsides of the reduction area SG. Due to the directional correction process, as shown in FIG. 4B, the reduction area SG of the original image IG1 is deformed to a reduction area SM having a reduced length in the direction of deformation, and each of the extension areas EG of the original image IG1 is deformed to an extension area EM having an extended length in the direction of deformation. Thus, a face FM1 of a deformed image IM1 is slimmer than the face FG1 of the original image IG1.

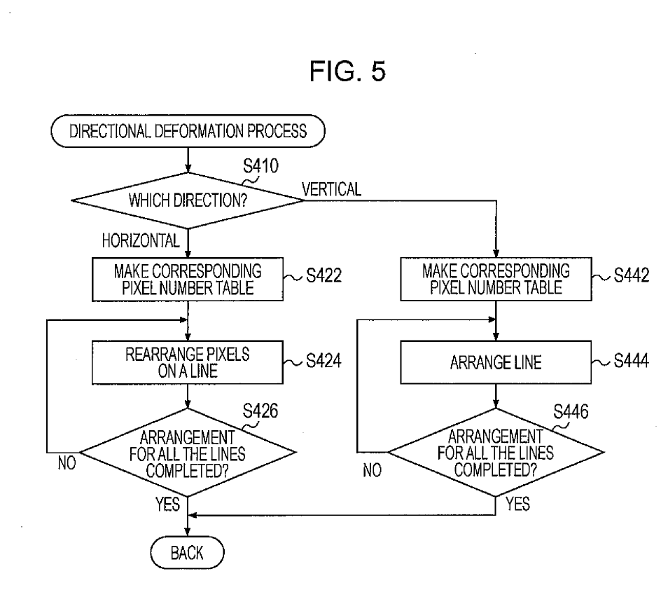

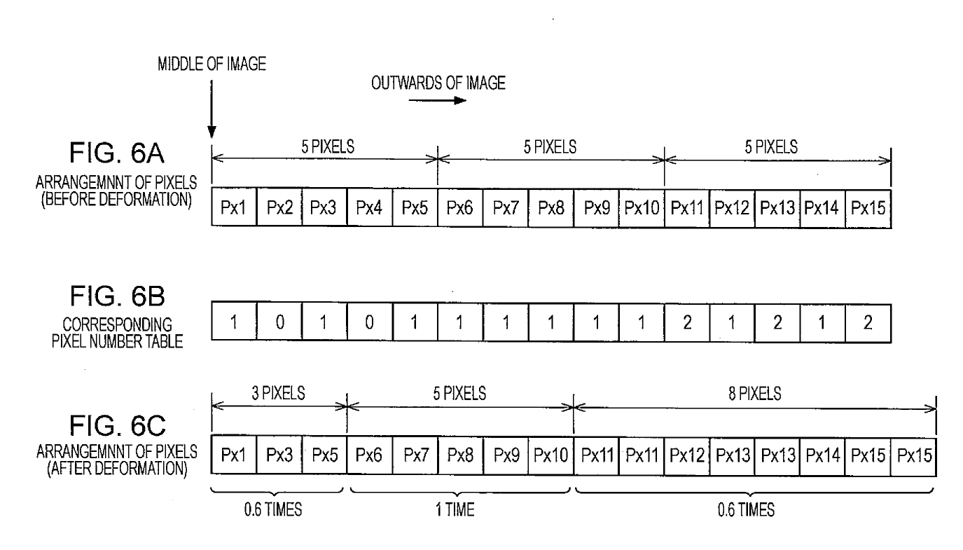

FIG. 5 is a flowchart of the directional deformation process performed at the step S400. FIGS. 6A-6C shows a model of the directional deformation process in a case where the direction of deformation is horizontal. FIG. 6A shows an arrangement of pixels before the directional deformation process, i.e., before the correction. FIG. 6B shows an example of the corresponding pixel number table 420. FIG. 6C shows an arrangement of pixels of an image that has been directionally deformed (deformed image).

At a step S410, the directional correction process unit 230 judges in which direction, horizontal or vertical, the direction of deformation has been set. If the direction of deformation is horizontal, the flow moves on to a step S422. If the direction of deformation is vertical, the flow moves on to a step S442.

At the step S422, a corresponding pixel number table generator 232 of the directional correction process unit 230 makes the corresponding pixel number table 420. The corresponding pixel number table 420 is a table representing the number of pixels of the deformed image each of which corresponds to each of pixels of the original image. The corresponding pixel number table generator 232 determines the number of the corresponding pixels of the deformed image (corresponding pixel number) on the basis of the reduction rate and the extension rate (magnification) set in each of areas of the image arranged in the horizontal direction. Then, the corresponding pixel number table generator 232 stores the determined corresponding pixel number in the corresponding pixel number table 420 so as to make the corresponding pixel number table 420. As for the first embodiment, if the direction of deformation is horizontal, the image is deformed to be left-to-right symmetric. Thus, it is enough for the corresponding pixel number table 420 to have a half as many as the whole number of the pixels in the horizontal direction, so that a memory size required for the directional deformation process may be reduced.

The corresponding pixel number table generator 232 can determine the corresponding pixel number by, e.g., binary-digitizing a decimal portion of the magnification by using a half tone process so as to determine an arrangement pattern of “0”s and “1”s, and by adding an integer portion of the magnification to the value “0” or “1” of the arrangement pattern. The corresponding pixel number table generator 232 can use a known method such as dithering or error diffusion for the half tone process. The corresponding pixel number table generator 232 can use an arrangement pattern stored beforehand for the decimal portion of each of the magnifications. At the step S422, the corresponding pixel number table generator 232 may use a corresponding pixel number table that has been made beforehand instead of making the corresponding pixel number table.

As shown in FIG. 6, e.g., the magnifications in the horizontal direction are set to 0.6, and 1.6 for every five pixels from the middle of the original image. Thus, for each of three pixels Px1, Px3 and Px5 of the initial five pixels Px1-Px5, the corresponding pixel number is set to one. For each of the remaining two pixels Px2 and Px4, the corresponding pixel number is set to zero. For each of all the next five pixels Px6-Px10 for which the magnification is set to one, the corresponding pixel number is set to one. For each of three pixels Px11, Px13 and Px15 of the outmost five pixels of the original image for which the magnification is set to 1.6, the corresponding pixel number is set to two. For each of the remaining two pixels Px12 and Px14 of the outmost five pixels, the corresponding pixel number is set to one.

At a step S424 shown in FIG. 5, the corresponding pixel arrangement process unit 234 (shown in FIG. 1) rearranges the pixels on a line of the original image stored in the image buffer 410. The line is a process unit for processing an image, and is a linear area extended in the horizontal direction that is as long as the whole pixel number in the horizontal direction, and is as wide as one pixel. Depending on a method for storing the image in the image buffer 410, however, a linear area extending in the vertical direction may be treated as the line.

The corresponding pixel arrangement process unit 234 (shown in FIG. 1) rearranges the pixels stored in the image buffer 410 outwards from the middle of the image in accordance with the corresponding pixel number stored in the corresponding pixel number table 420. The corresponding pixel arrangement process unit 234 can rearrange the pixels in condition that pixels not yet rearranged remain in the image buffer 410 by rearranging the pixels outwards from the middle of the image. Thus, the corresponding pixel arrangement process unit 234 can rearrange the pixels by using the single image buffer 410 so that a memory size required for the directional deformation process may be reduced.

As shown in FIG. 6C, e.g., the pixels Px1, Px3, Px5-Px10 for each of which the corresponding pixel number is set to one are rearranged from the middle of the image in order. Then, in accordance with the corresponding pixel number, the pixels Px11, Px12, Px13, Px14 and Px15 are rearranged to two pixels, one pixel, two pixels, one pixel and two pixels, respectively. The middle and outmost areas of the original image of five pixels are reduced at a magnification of 0.6 times and extended at a magnification of 1.6 times, respectively. As for the first embodiment, as shown in FIGS. 6A-6C, the magnification of each of the areas in the horizontal direction is set in such a way that the number of the pixels after the rearrangement is a bit greater than the number of the pixels of the original image. Thus, the deformed image is longer than the original image in the direction of deformation.

At a step S426 shown in FIG. 5, the directional correction process unit 230 judges if the rearrangement of the pixels is completed for all the lines of the original image. In a case where the rearrangement of the pixels is completed for all the lines of the original image, the directional deformation process shown in FIG. 5 ends, and the flow moves back to the facial shape correction print process shown in FIG. 3. Meanwhile, in a case where the rearrangement of the pixels is not completed, the flow moves back to the step S424, and the steps S424 and S426 are repeated until the rearrangement of the pixels is completed for all the lines.

At the step S442, the corresponding pixel number table generator 232 makes the corresponding pixel number table 420 similarly as at the S422. In a case where the direction of deformation is vertical, the corresponding pixel number table 420 is made in accordance with the number of the pixels arranged in the vertical direction. As a method for determining the number of the corresponding pixels is a same as that of the step S422, its explanation is omitted.

At a step S444, the directional correction process unit 230 arranges a line of the original image in a storage area of the deformed image set in the image buffer 410 with reference to the corresponding pixel number table 420. More specifically, in the storage area of the deformed image of the image buffer 410, the directional correction process unit 230 adds one line of the original image stored in the image buffer 410 as a line of the corresponding pixel number.

At a step S446, the directional correction process unit 230 judges if the arrangement of all the lines of the original image is completed. In a case where the arrangement of all the lines is completed, the directional deformation process shown in FIG. 5 ends, and the flow moves back to the facial shape correction print process shown in FIG. 3. Meanwhile, in a case where the arrangement of the lines is not completed, the flow moves back to the step S444, and the steps S444 and S446 are repeated until the arrangement of all the lines is completed.

After the flow comes back from the directional deformation process shown in FIG. 5, at a step S500 shown in FIG. 3, the directional correction process unit 230 trims the deformed image. As for the first embodiment, as shown in FIG. 4B, the directionally deformed image is made longer than the original image in the direction of deformation. Thus, a trimming process, i.e., cutting away edge portions in the direction of deformation of the deformed image is performed so that the deformed image becomes a corrected image having a same length as the original image. As shown in FIG. 4B, left and right edge portions of the deformed image IM1 are cut away so that the corrected image IT1 having a same length as the original image IG1 in the horizontal direction is produced.

At a step S600 shown in FIG. 3, the print processor 320 performs a color conversion process, a half tone process and so forth on the corrected image so as to produce print data. The print processor 320 provides the print engine 140 with the produced print data so as to print an image on which the facial shape correction process has been performed.

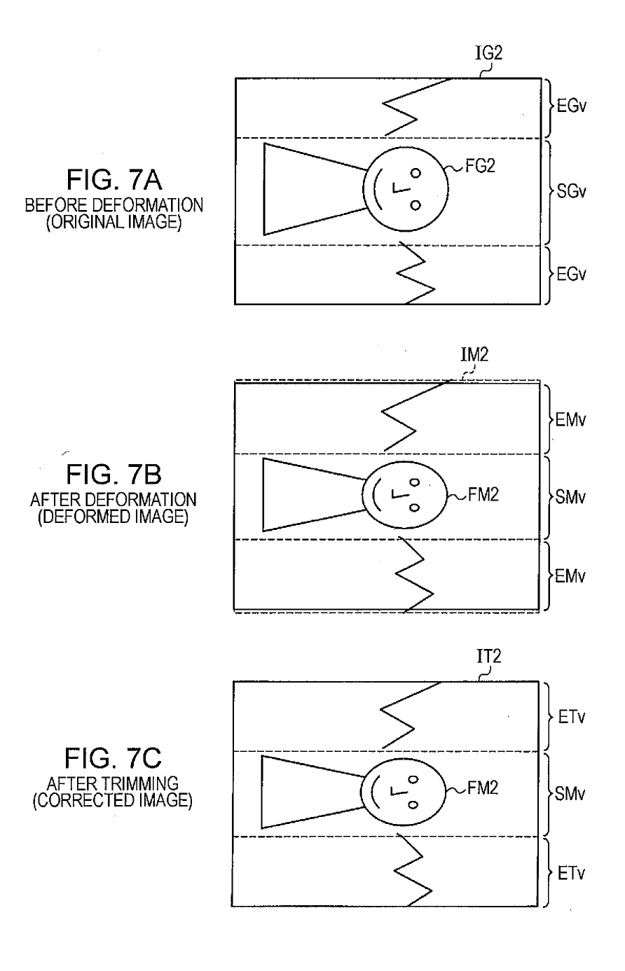

FIGS. 7A-7C illustrate an example of the facial shape correction process in which an image IG2 corresponding to the thumbnail image TN2 shown in FIG. 2 is corrected. FIG. 7A shows the original image IG2 before the facial shape correction process. FIG. 7B shows the deformed image IM2 that has been directionally deformed at the step S400. FIG. 7C shows the corrected image IT2 that has been trimmed at the step S500.

As shown in FIG. 7A, as a top-to-bottom direction of a face FG2 of the original image IG2 almost coincides with the horizontal direction of the image IG2, the inclination of the face is identified to be almost 90 degrees at the step S200. Thus, at the step S300 (shown in FIG. 3), the direction of deformation is set to the vertical direction of the original image IG2.

As shown in FIG. 7, e.g., as the direction of deformation is vertical, a reduction area SGv is arranged in the middle of the vertical direction of the original image IG2. High and low outmost areas SGv of the image IG2 above and below the reduction area SGv are set to be extension areas. Then, at the step S400, the original image IG2 is directionally deformed so that the deformed image IM2 shown in FIG. 7B is produced. Due to the directional deformation process, a reduction area SMv of the deformed image IM2 is made shorter than the reduction area SGv of the original image IG2 in the direction of deformation (vertical direction). An extension area EMv of the deformed image IM2 is made longer than the extension area EGv of the original image 1G2 in the vertical direction. Thus, also in a case where the top-to-bottom direction of the face FG2 is in the horizontal direction of the original image IG2, a face FM2 of the deformed image IM2 is made slimmer than the face FG2 of the original image IG2. After the deformed image IM2 is produced, as shown in FIG. 7C, top and bottom end portions of the deformed image IM2 are cut away so that the deformed image IM2 is trimmed and the corrected image IT2 having a same length as the original image IG2 in the vertical direction is produced at the step S500.

According to the first embodiment, as described above, the direction of deformation is set on the basis of the facial arrangement of the original image and the original image is extended and reduced in the direction of deformation, so that the human face may be made slim regardless of the direction of the face.

According to the first embodiment, in a case where the direction of deformation is horizontal, i.e., equal to the direction of the line that is the image processing unit, the reduction and extension areas may be arranged symmetric with respect to the middle of the image so that the memory size required for the deformation in the direction of the line may be reduced.

As for the first embodiment, after the corrected image is produced at the step S500 of the trimming process, the print data is produced at the step S600. Instead, the print data may be produced after the process for each of the lines is completed at the step S424 or S444 (shown in FIG. 5). In that case, if the direction of deformation is horizontal, pixels of both ends of each of the lines are cut away so that the image is trimmed. Meanwhile, if the direction of deformation is vertical, the directional deformation process is performed from the line initially processed in order, and then stopped after a determined number of the lines are processed so that the image is trimmed. Thus, one of the end portions of the deformed image in the vertical direction has been cut away in the trimmed corrected image.

### B. Second Embodiment

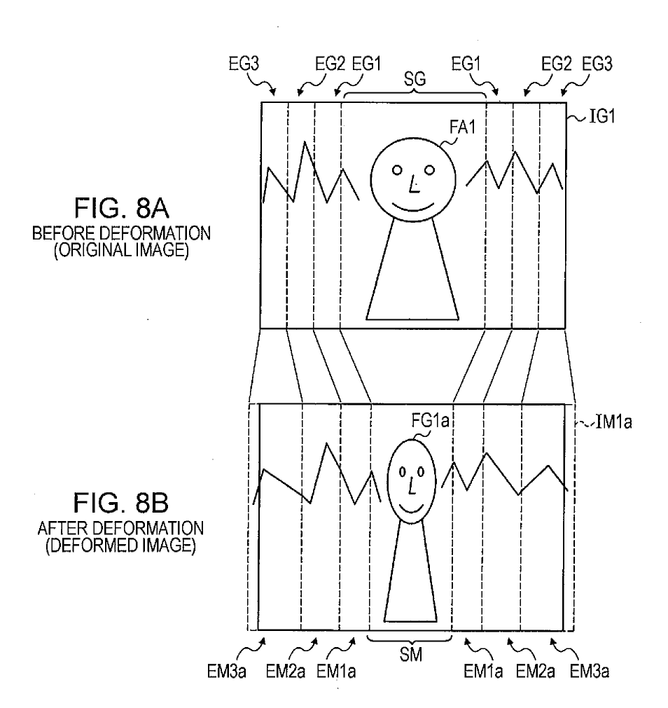

FIGS. 8A and 8B illustrate a facial shape correction process of the second embodiment in which the image IG1 corresponding to the thumbnail image TN1 shown in FIG. 2 is corrected. The second embodiment is different from the first embodiment shown in FIG. 4 in a way of extending the extension area. Other than that, the second embodiment equals the first embodiment.

As for the second embodiment, as shown in FIG. BA, three extension areas EG1-EG3 are arranged at each of the left and right outsides of the reduction area SG. Extension rates of these extension areas EG1-EG3 are set to increase in order from the middle of the direction of deformation towards the outside. Thus, as for a deformed image IM1a shown in FIG. 8B, an image of an extension area EM1a on a side of the reduction area SM is deformed little, and an image of an outmost extension area EM3a is significantly deformed.

As for the second embodiment, as described above, the extension rate of the extension area EG1 on the side of the reduction area SG is made so small that a feeling of wrongness between the reduction area SM and the extension area EM1a of the deformed image IM1a caused by difference of the magnification is reduced. The extension rate of the outmost extension area EG3 is made so great that the deformed image IM1a may be long enough in the direction of deformation. The deformed image IM1a can be prevented from producing a blank at an end portion of the direction of deformation, thereby.

As for the second embodiment, the three extension areas of different extension rates EG1-EG3 are arranged outside the reduction area SG. Generally speaking, though, it is enough that the extension rate at a position close to the reduction area is smaller than the extension rate at a position distant from the reduction area. The extension rate need not monotonously increase with the distance from the reduction area. As the extension rate at the position close to the reduction area is made small in this way, the feeling of wrongness produced between the reduction area and the extension area of the deformed image can be reduced.

### C. Third Embodiment

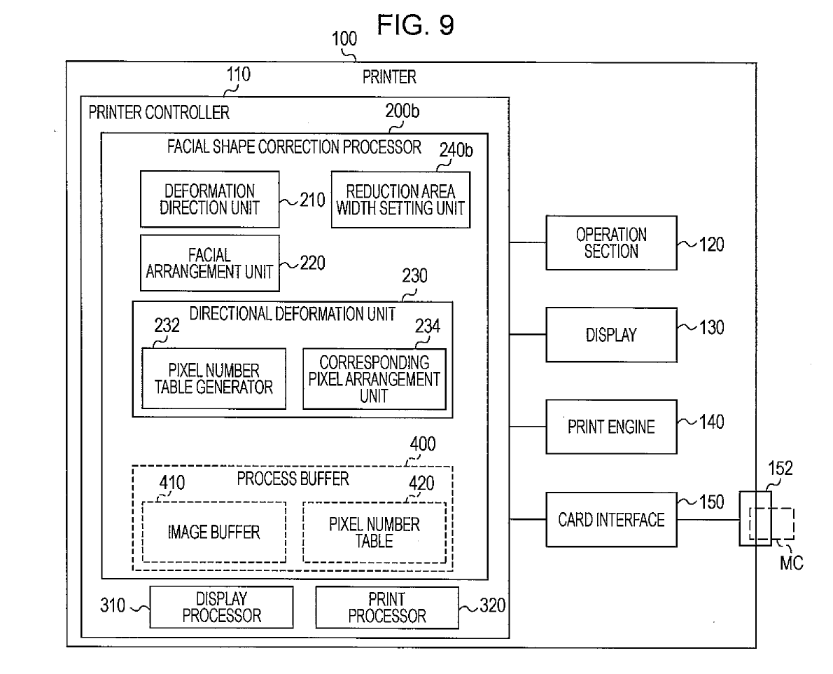

FIG. 9 is a schematic block diagram of a printer 100b of the third embodiment. The printer 100b is different from the printer 100 of the first embodiment in that a facial shape correction processor 200b has a reduction area width setting unit 240b. Other than that, the printer 100b equals the printer 100 of the first embodiment.

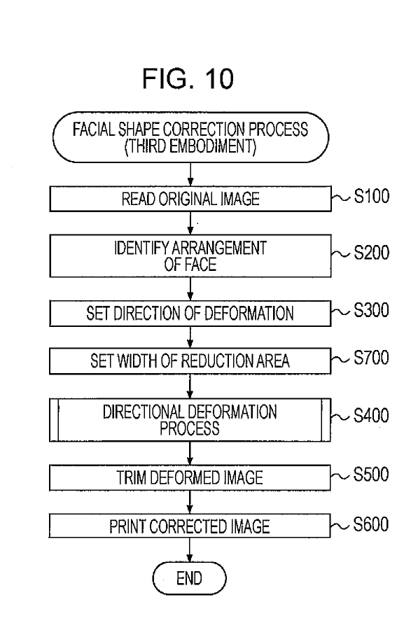

FIG. 10 is a flowchart of a facial shape correction print process of the third embodiment. The flowchart shown in FIG. 10 is different from the flowchart of the facial shape correction print process of the first embodiment in that a step S700 is added between the steps S300 and S400.

At the step S700, the reduction area width setting unit 240b sets a width of the reduction area of the original image on the basis of the facial arrangement identified at the step S200. More specifically, the reduction area width setting unit 240b sets the width of the reduction area so that the face in which the arrangement has been identified at the step S200 is included in the reduction area.

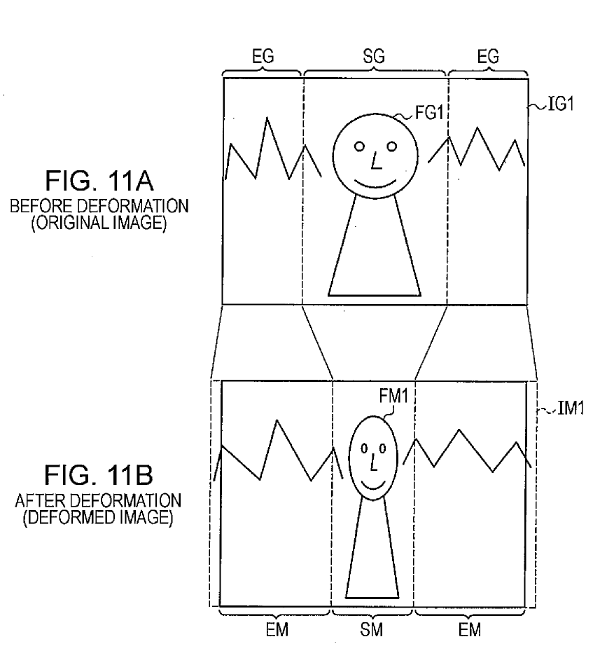

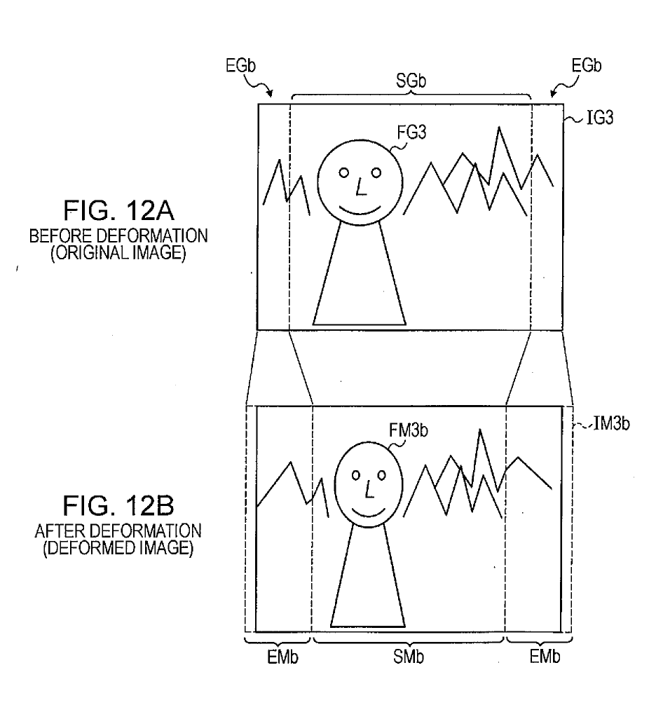

FIG. 11 illustrates a facial shape correction process in which the image IG1 corresponding to the thumbnail image TN1 shown in FIG. 2 is corrected. FIG. 12 illustrates a facial shape correction process in which the image IG3 corresponding to the thumbnail image TN3 shown in FIG. 2 is corrected. FIG. 11 is a same drawing as FIG. 4. In FIG. 12, the original image IG3 to be corrected in the facial shape correction process is different from the original image IG1 shown in FIG. 11.

As shown in FIG. 11, if the face FG1 of the original image IG1 is positioned in the middle of the original image IG1, the width of the reduction area SG is set on the basis of the width of the face FG1. Thus, as for the example shown in FIG. 11, the reduction area SG and the extension area EG are set similarly to the first embodiment. The original image IG1 is directionally deformed similarly to the first embodiment. Each of the widths of the reduction area SG and the extension area EG is a same as that of the first embodiment shown in FIG. 4.

Meanwhile, as shown in FIG. 12A, the original image IG3 corresponding to the thumbnail image TN3 shown in FIG. 2 equals the original image IG1 shown in FIG. 11 in that the top-to-bottom direction of the human face almost coincides with the vertical direction, and the inclination of the face is almost zero degrees. Thus, at the step S300 (shown in FIG. 3), the direction of deformation is set in the horizontal direction of the original image IG3. Meanwhile, the person is positioned out of the middle and close to the left side in the horizontal direction of the original image IG3. Thus, at the step S700, the length of a reduction area SGb is set to be so wide as to include a human face FG3 in the direction of deformation (horizontal).

After the directional deformation process is performed, as shown in FIG. 12B, the reduction area SGb of a deformed image IM3b is shorter than the reduction area SGb of the original image IG3 in the horizontal direction. And an extension area EMb of the deformed image IM3b is longer than the extension area EGb of the original image IG3 in the horizontal direction. Thus, the deformed image IM3b includes a human face FM3b deformed to be slimmer than the human face FG3 of the original image IG3.

As for the third embodiment, as described above, the width of the reduction area positioned in the middle of the direction of deformation is set in accordance with the position of the human face. Thus, if the human face is positioned around the middle, the original image is directionally deformed similarly to the first embodiment so that the human face is made slimmer than the face of the original image. If the face is positioned out of the middle, the reduction area is set to be wide. Thus, even if the face is positioned out of the middle of the image, the face can be deformed to be slimmer than the face of the original image.

According to the third embodiment, as described above, the width of the reduction area is set in accordance with the position of the face so that the face can be deformed to be slimmer than the face of the original image, even if the face is positioned out of the middle of the image. As the reduction area is set in accordance with the position of the face, the extension area is set across from an end portion of the reduction area to an end portion of the image. It may be said that a starting position of the extension area is arranged in accordance with the position of the face.

As for the third embodiment, the image is extended and reduced symmetrically with respect to the middle of the image similarly to the first embodiment. Thus, if the direction of deformation coincides with the direction of the line, pixels of the deformed image can be arranged before the arrangement of the pixels of the original image is changed, so that the memory size required for the directional deformation process can be reduced.

As for the third embodiment, the reduction area is set to be so wide as to include the face of the original image. Generally speaking, though, it is enough that the face is prevented from being extended in the direction of deformation. In that case, a non-deformed area that is neither reduced nor extended may be arranged next to and outside the reduction area, so that the non-deformed area may include the human face. In that case, the non-deformed area is arranged symmetrically with respect to the middle of the image so that the memory size required for the directional deformation process can be reduced. In a case where the facial shape of the deformed image produces no feeling of wrongness even if the extension area includes a portion of the face, the extension area may include the portion of the face.

### D. Fourth Embodiment

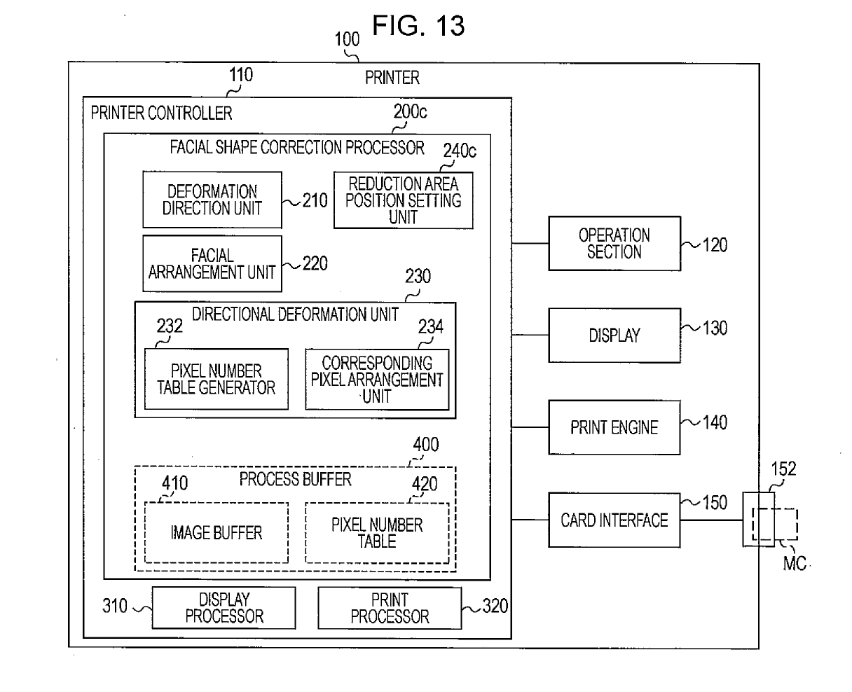

FIG. 13 is a schematic block diagram of a printer 100c of the fourth embodiment. The printer 100c is different from the printer 100 of the first embodiment in that a facial shape correction processor 200c has a reduction area position setting unit 240c. Other than that, the printer 100c equals the printer 100 of the first embodiment.

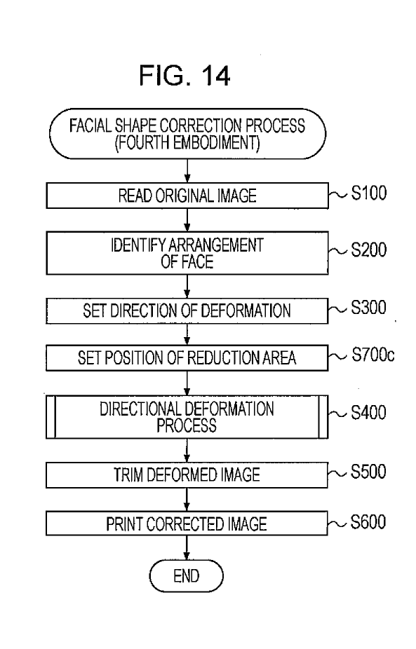

FIG. 14 is a flowchart of a facial shape correction print process of the fourth embodiment. The flowchart shown in FIG. 14 is different from the flowchart of the facial shape correction print process of the first embodiment shown in FIG. 3 in that a step S700c is added between the steps S300 and S400.

At the step S700c, the reduction area position setting unit 240c sets a position of the reduction area of the original image on the basis of the facial arrangement identified at the step S200. More specifically, the reduction area position setting unit 240c sets an area having a width calculated on the basis of the width of the face (erg., 2.5 times as wide as the face) centered with respect to the face in which the arrangement has been identified at the step S200. If the original image includes a plurality of faces, the reduction area is set for each of the faces. If inclinations of the plural faces are divided by a border of 45 degrees, no reduction area is set for one of the faces having a top-to-bottom direction close to the direction of deformation.

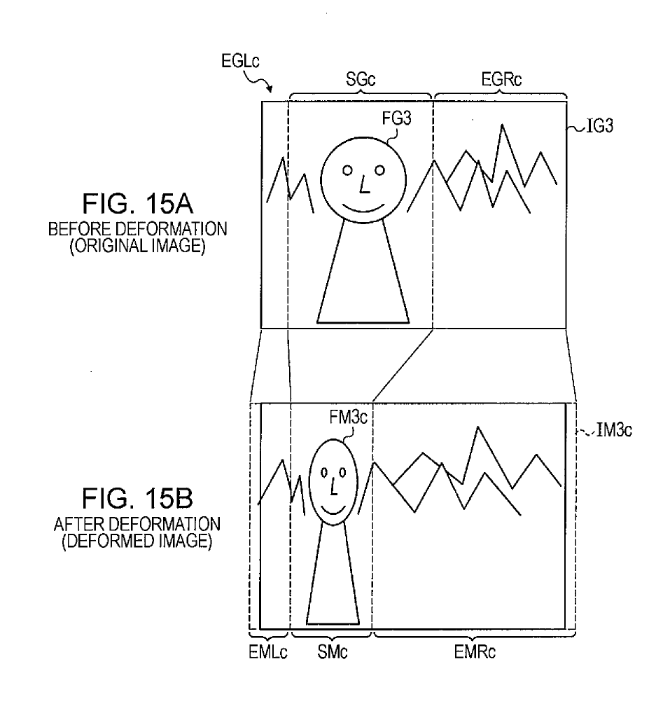

FIGS. 15A and 15B illustrate the facial shape correction process in which the image IG3 corresponding to the thumbnail image TN3 shown in FIG. 2 is corrected. FIG. 15A shows the original image IG3 before the facial shape correction process. FIG. 15B shows a deformed image IM3c that has been directionally deformed at the step S400.

As the inclination of the face in the image IG3 shown in FIG. 15A is almost zero degrees, as described above, the direction of deformation is set in the horizontal direction of the image IG3. Meanwhile, the human face FG3 is positioned out of the middle and off to the left side in the horizontal direction of the image IG3, i.e., the direction of deformation. Thus, at the step S700c, the reduction area is set to an area SGc centered with respect to the face FG3. At each of the left and right outsides of the reduction area SGc, extension areas EGLc and EGRc are arranged, respectively.

In a case where the center of the reduction area SGc is arranged close to the one end portion of the image, as described above, the pixels are rearranged from the center of the reduction area SGc towards the outside at the step S424 shown in FIG. 5. In that case, the size of the corresponding pixel number table 420 corresponds to the number of the pixels between the center of the reduction area SGc and the other end portion of the image.

After the directional deformation process is performed, as shown in FIG. 15B, the deformed image IM3c has a reduction area SMc that is shorter than the reduction area SGc of the original image IG3 in the horizontal direction, and extension areas EMLc and EMRc which are longer than the extension areas of the original image. Thus, the human face FM3c of the deformed image IM3c is deformed to be slimmer than the face FG3 of the original image IG3. The reduction area SGc of the original image IG3 is made narrower than in the case where the reduction area SGc is positioned in the middle of the image IG3. Thus, even in a case where the face FG3 is positioned at the end portion of the image IG3, the whole extension area formed by combining the left and right extension areas EGLc and EGRc can be made wide enough. Thus, even if no blank is produced at the end portion of the deformed image IM3c in the direction of deformation, the extension rates of the extension areas EGLc and EGRc can be set to be lower so that a chance of a feeling of wrongness of the corrected image caused by an increase of the extension rate can be reduced.

As for the fourth embodiment, as described above, the reduction area centered with respect to the face is set so that the face included in the reduction area is deformed to be slim. Thus, even if a person is positioned at an end portion of the image, the face can be deformed to be slim. The center of the reduction area can be set to the position of the face so that the extension area can be made wide enough. A chance of a feeling of wrongness of the corrected image caused by increase of the extension rate can be reduced, thereby.

As for the fourth embodiment, as shown in FIG. 15, the extension areas EGLc and EGRc are arranged at both end portions of the direction of deformation. Depending on the position of the face, though, the extension area may be arranged at one end portion. If a distance between the position of the face and the end of the image is shorter than a determined length (e.g., one twentieth of the length in the direction of deformation), no extension area may be positioned on the side of that end of the image.

### E. Fifth Embodiment

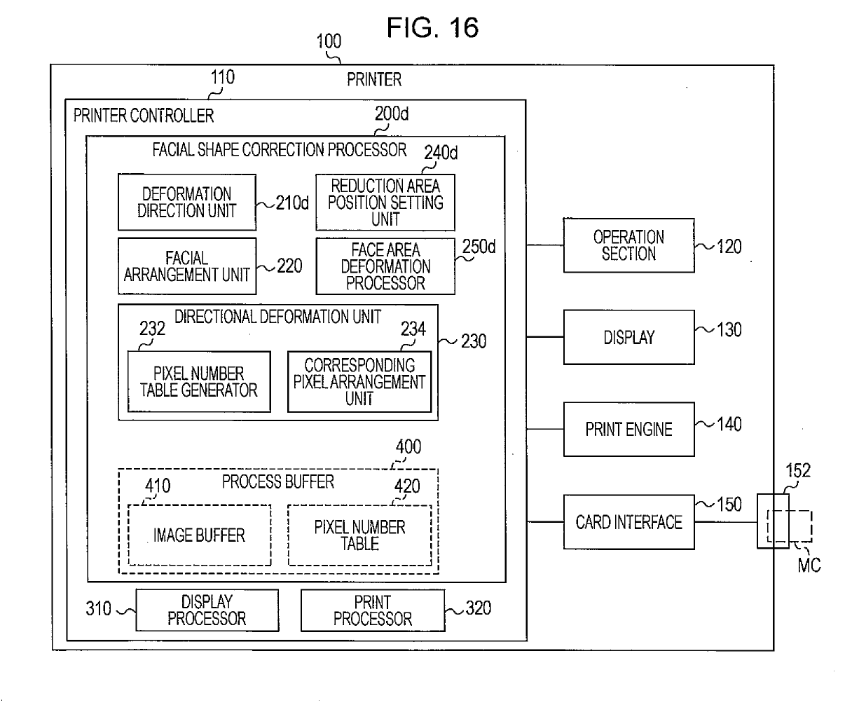

FIG. 16 is a schematic block diagram of a printer 100d of the fifth embodiment. The printer 100d is different from the printer 100c of the fourth embodiment shown in FIG. 13 in that a deformation direction setting unit 210d and a reduction area width setting unit 240d have different functions from those of the printer 100c, and that a facial shape correction processor 200d has a face area deformation processor 250d. Other than that, the printer 100d equals the printer 100c of the fourth embodiment.

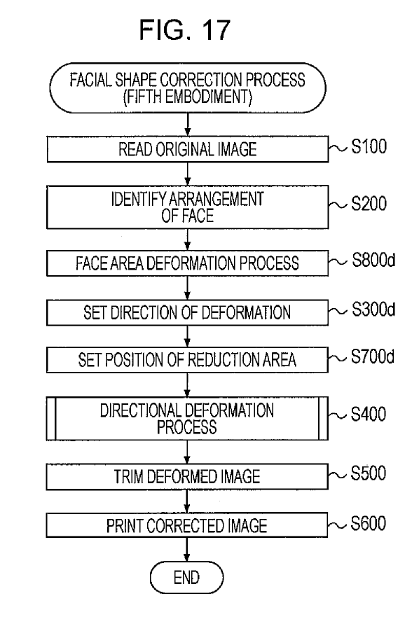

FIG. 17 is a flowchart of a facial shape correction print process of the fifth embodiment. The flowchart shown in FIG. 17 is different from the flowchart of the facial shape correction print process of the fourth embodiment shown in FIG. 14 in that the two steps S300 and S700c are replaced by S300d and S700d, respectively, and that a step S800d is added between the steps S200 and S300d.

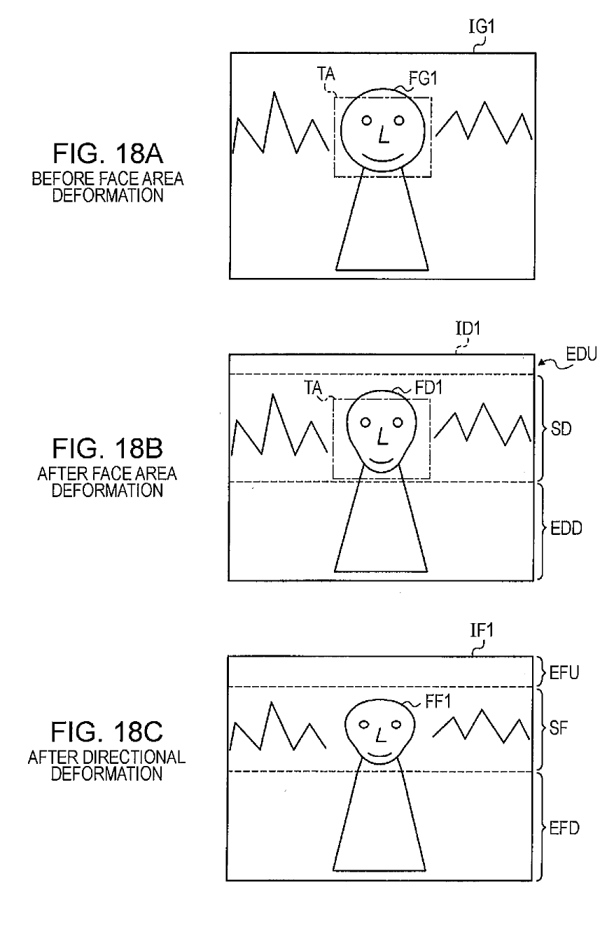

FIG. 18 illustrates the facial shape correction process in which the image IG1 corresponding to the thumbnail image TN1 shown in FIG. 2 is corrected. FIG. 18A shows the original image IG1 before the facial shape correction process. FIG. 18B shows an image ID1 that has been deformed in a face area deformation process (described later) at the step S800d. FIG. 18C shows a deformed image IF1 directionally deformed at the step S400.

At the step S800d shown in FIG. 17, the face area deformation processor 250d sets a face area to be deformed on the basis of the facial arrangement identified at the step S200. The face area deformation processor 250d makes correspondences between points in the face area after the deformation and points in the face area before the deformation (mapping) so as to deform the image in the face area. The face area deformation process using the mapping process will be described later.

As shown in FIG. 18A, e.g., a face area TA is set to overlap the face FG1. Then, the shape of the face FG1 in the original image IG1 is deformed in the deformation process using the mapping process. As shown in FIG. 18B, the deformation process makes cheeks of a human face FD1 in the deformed image ID1 slimmer than those of the face FG1 in the original image IG1.

Contrary to the step S300 of the fourth embodiment, if the inclination of the face is smaller than 45 degrees at the step S300d shown in FIG. 17, the deformation direction setting unit 210d sets the direction of deformation to the vertical direction. Meanwhile, if the inclination of the face is greater than 45 degrees, the deformation direction setting unit 210d sets the direction of deformation to the horizontal direction. At the step S700d, then, the reduction area width setting unit 240d sets the position of the reduction area on the basis of the arrangement of the face area in the direction of deformation.

As shown in FIG. 18B, the direction of deformation is set to the vertical direction of the image. A reduction area SD is set longer than the face area TA in the vertical direction (direction of deformation). The face area TA is arranged below the forehead of the person as described later. Thus, an upper end of the reduction area SD is arranged outside of an upper end of the face area TA. Then, extension areas EDU and EDD are arranged above and below the reduction area SD, respectively.

After the position of the reduction area SD is set at the step S700d (shown in FIG. 17), the reduction area and the extension areas arranged outside of the reduction area are directionally deformed at the step S400, so that the deformed image is produced.

As for the deformed image IF1 that has been directionally deformed, as shown in FIG. 18C, a reduction area SF is shorter than the reduction area SD of the image ID1 in the vertical direction. Extension areas EFU and EFD are longer than the corresponding extension areas EDU and EDD of the image ID1, respectively, in the vertical direction. As described above, the face FD1 deformed to be longer than is wide in the face area deformation process (step S800d) is made shorter in the vertical direction in the directional deformation process (step S400). Thus, even if the facial shape is corrected so much in the face area deformation process that the face is deformed to be yet longer than is wide, a ratio between lengths of the face in the top-to-bottom and left-to-right directions may be made nearly equal to the corresponding ratio of the original image IG1. Thus, even if an effect of the face area deformation process is enhanced, the face may be prevented from looking longer than is wide so that an image without a feeling of wrongness can be produced.

As for the fifth embodiment, as described above, even the face that has been deformed to be longer than is wide can be directionally deformed so that a length and width ratio of the face being close to that of the original face can be obtained. Thus, the image on which the face area deformation process has been performed can reduce a feeling of wrongness.

### F. Facial Arrangement Identification

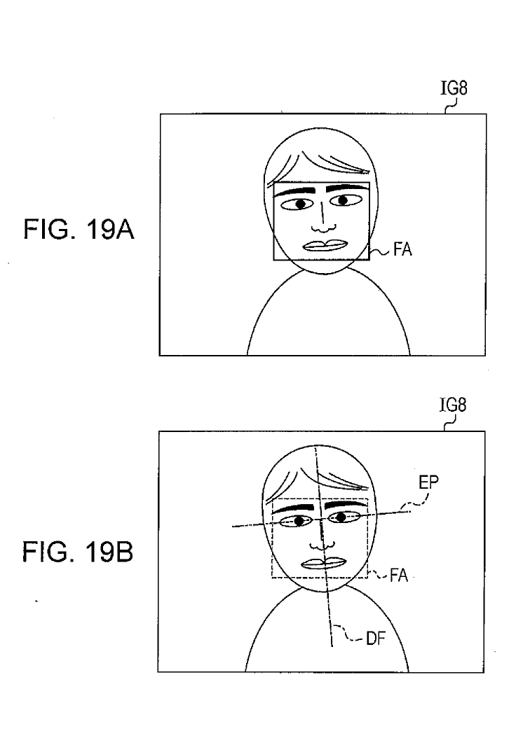

FIGS. 19A and 19B shows an example of the facial arrangement identification process performed at the step S200 shown in FIG. 3. In FIG. 19, an image IG8 corresponding to a thumbnail image TN8 shown in FIG. 2 is processed.

For obtaining the facial arrangement, the facial arrangement identification unit 220 detects a rough position of the face from the image at first. In FIG. 19A, e.g., an area FA representing the rough position of the face has been detected. The facial arrangement identification unit 220 detects the area FA (hereinafter may be called “detected face area FA”) by using a known method for detecting a face such as a pattern matching by using a template (refer to JP-A-2004-318204). The detected face area FA is a rectangular area including eyes, a nose and a mouth of the human face.

Next, the facial arrangement identification unit 220 identifies positions of left and right pupils by analyzing the detected face area FA. Then, the facial arrangement identification unit 220 identifies a central line DF as a line that characterizes the position and the top-to-bottom direction of the face. The line DF is perpendicular to a line EP that connects the positions of the left and right pupils, and passes a center between the left and right pupils.

### G. Facial Area Deformation

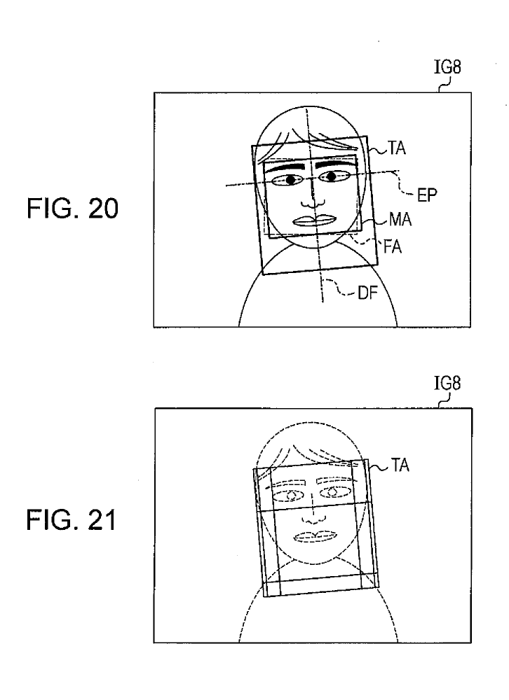

FIGS. 20-23 illustrate an example of the face area deformation process performed at the step S800d shown in FIG. 17. In FIGS. 20-23, the image IGB corresponding to the thumbnail image TN8 shown in FIG. 2 is processed similarly as in FIGS. 19A and 19B.

As for the face area deformation process, the face area deformation processor 250d sets a mapping deformation area TA in which the deformation process using mapping is performed on the basis of the facial arrangement identified at the step S200. As shown in FIG. 20, the mapping deformation area TA is set as an area that covers between below the chin and above the eyebrows in the top-to-bottom direction. The mapping deformation area TA is set as an area that covers a whole outline of the face in the left-to-right direction.

In order to set the mapping deformation area TA, at first, the direction of the detected face area FA is arranged in accordance with the inclination of the face so that a face area MA is set. The face area MA in which the inclination has been arranged is extended in directions upper and lower than the line EP connecting the pupils and leftward and rightward directions of the central line DF, at a determined magnification for each of the above directions, so that the mapping deformation area TA is set.

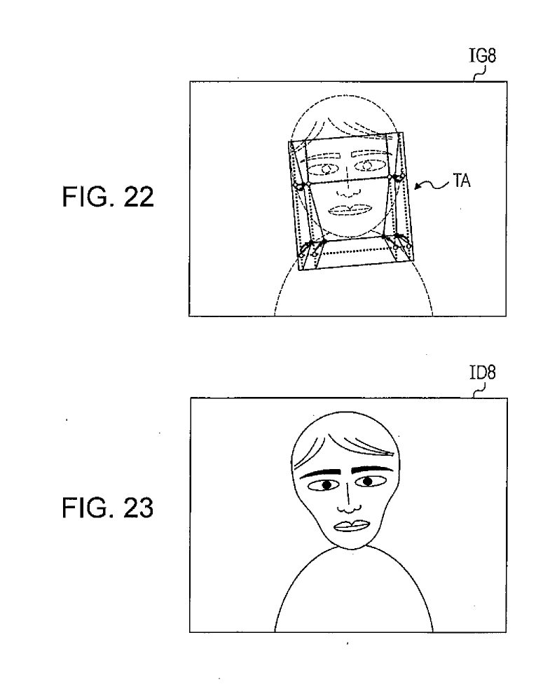

The mapping deformation area TA is divided into a plurality of sub-areas as shown in FIG. 21. Then, as shown in FIG. 22, a mapping process is performed in such a way that lattice points before the deformation shown by white dots move to lattice points after the deformation shown by white dots. By setting values of pixels on the basis of the mapping process, as shown in FIG. 23, the image in the mapping deformation area TA is deformed and an image ID8 in which the face has been deformed to be slim is produced by the face area deformation process.

In general, the face area deformation process may be another type of deformation process as long as the image is deformed in a deformation area. For example, an image in the middle of the deformation area may be reduced along the line EP, and an image at an end portion of the deformation area may be extended along the line EP.

### H. Modifications

The invention is not limited to the examples or the embodiments described above, and may be implemented in various forms, such as following modifications.

### H1. First Modification

Although the extension area of the third to fifth embodiments described above are extended at a constant extension rate in the direction of deformation, the extension rate can be changed in accordance with the distance from the reduction area, similarly to the second embodiment.

### H2. Second Modification

Although being applied to the deformation process of a facial shape as for the above embodiments, the invention can be applied to a deformation process different from the deformation process of the facial shape. The invention can be generally applied to a deformation process of an object included in an image.

### H3. Third Modification

Although being applied to the printer as for the above embodiments, the invention can be applied to any device as long as it is configured to perform a directional deformation process on an original image. The invention can be applied to, e.g., a personal computer or a digital still camera as long as it is configured to perform an image deformation process.

### H4. Fourth Embodiment

As for the above embodiments, some portions implemented by hardware may be implemented by software, and vice versa.

The present application claims the priority based on a Japanese Patent Application No. 2008-076268 filed on Mar. 24, 2008, the disclosure of which is hereby incorporated by reference in its entirety.

What is claimed is:

1. An image processing device, comprising:
a deformation area setting unit configured to set an extension area and a reduction area in an image; and
a deformation processing unit configured to extend the extension area in a particular direction, the deformation processing unit being configured to reduce the reduction area in the particular direction at a constant reduction rate.

2. The image processing device according to claim 1, wherein the deformation processing unit is configured to assign a first extension rate and a second extension rate to a first position and a second position in the extension area, respectively, the second position being nearer to the reduction area than the first position, the second extension rate being smaller than the first extension rate.

3. The image processing device according to claim 2, wherein the deformation processing unit is configured to extend the extension area in the particular direction at an extension rate monotonously increasing with a distance in the particular direction from the reduction area.

4. The image processing device according to claim 1, wherein the image includes a human face, and the deformation area setting unit is configured to set the reduction area in such a way that the reduction area includes the human face.

5. A method for image processing, comprising;
setting an extension area and a reduction area in an image;
extending the extension area in a particular direction; and
reducing the reduction area in the particular direction at a constant reduction rate.

6. A computer program for image processing, comprising:
a function of setting an extension area and a reduction area in an image;
a function of extending the extension area in a particular direction; and
a function of reducing the reduction area in the particular direction at a constant reduction rate.
